(19) United States
(12) Patent Application Publication
(10) Pub. No.: US 2023/0161824 A1
(43) Pub. Date: May 25, 2023

(54) MANAGEMENT OF DATA ACCESS USING A VIRTUAL REALITY SYSTEM

(71) Applicant: International Business Machines Corporation, Armonk, NY (US)

(72) Inventors: Sushain Pandit, Austin, TX (US); Sarbajit K. Rakshit, Kolkata (ID)

(21) Appl. No.: 17/456,209

(22) Filed: Nov. 23, 2021

(51) Int. Cl. G06F 16/93; G06T 19/00; G06F 3/01

(52) U.S. Cl. CPC G06F 16/93; G06T 19/003; G06F 3/017

(57) ABSTRACT

In an approach to improve management of user access to data using a virtual reality environment, embodiments generate a virtual reality interface depicting visual representations mapped to corresponding documents. The virtual reality interface provides a visual representation of mapped secondary users, and of mapped access controls. Further, embodiments enable a primary user to control secondary user access to documents contained in a repository. Additionally, responsive to receiving user gestures corresponding to the visual representations, embodiments update the visual representation and the corresponding mapped documents.

### BACKGROUND OF THE INVENTION

The present invention relates generally to the field of computer-generated virtual reality, and more particularly to computer data access management using a virtual reality system.

Gamification is the strategic attempt to enhance systems, services, organizations, and activities in order to create similar experiences to those experienced when playing games in order to motivate and engage users. This is generally accomplished through the application of game-design elements and game principles (dynamics and mechanics) in non-gaming contexts. It can also be defined as a set of activities and processes to solve problems by using or applying the characteristics of game elements. Gamification is part of persuasive system design, and it commonly employs game design elements to improve user engagement, organizational productivity, flow, learning, crowdsourcing, knowledge retention, employee recruitment and evaluation, ease of use, usefulness of systems, physical exercise, traffic violations, voter apathy, public attitudes about alternative energy, and more. A collection of research on gamification shows that a majority of studies on gamification find it has positive effects on individuals.

Virtual reality (VR) is a simulated experience that can be similar to or completely different from the real world. Applications of virtual reality include entertainment (e.g., video games), education (e.g., medical, or military training) and business (e.g., virtual meetings). Other distinct types of VR-style technology include augmented reality and mixed reality, sometimes referred to as extended reality (XR). Currently, standard virtual reality systems use either virtual reality headsets or multi-projected environments to generate realistic images, sounds and other sensations that simulate a user's physical presence in a virtual environment. A person using virtual reality equipment can look around the artificial world, move around in it, and interact with virtual features or items. The effect is commonly created by VR headsets consisting of a head-mounted display with a small screen in front of the eyes but can also be created through specially designed rooms with multiple large screens. Virtual reality typically incorporates auditory and video feedback but may also allow other types of sensory and force feedback through haptic technology.

### SUMMARY

Embodiments of the present invention disclose a computer-implemented method, a computer program product, and a system for managing user access to data using a virtual reality environment, the computer-implemented method comprising: generating a virtual reality interface depicting visual representations mapped to corresponding documents, wherein the virtual reality interface provides a visual representation of mapped secondary users, and of mapped access controls; enabling a primary user to control secondary user access to documents contained in a repository; and responsive to receiving user gestures corresponding to the visual representations, updating the visual representation and the corresponding mapped documents.

### BRIEF DESCRIPTION OF THE DRAWINGS

FIG. 1A is a functional block diagram illustrating a distributed data processing environment, in accordance with an embodiment of the present invention;

FIG. 1B is a functional block diagram illustrating a distributed data processing environment of a virtual reality data management system component, in accordance with an embodiment of the present invention;

FIG. 1C is a functional block diagram illustrating a distributed data processing environment of the virtual reality data management system component, in accordance with an embodiment of the present invention;

FIG. 2 illustrates operational steps of the virtual reality data management system component, on a server computer within the distributed data processing environment of FIGS. 1A-1C, for managing user data access using a virtual reality environment, in accordance with an embodiment of the present invention; and

FIG. 3 depicts a block diagram of components of the server computer executing the virtual reality data management system component within the distributed data processing environment of FIGS. 1A- 1C, in accordance with an embodiment of the present invention.

### DETAILED DESCRIPTION

Embodiments of the present invention recognize that files and folders are often stored in a document library, which may be hosted in a cloud storage system or local storage. Embodiments of the present invention recognize that in many scenarios, there is a need to grant access to a plurality of users with a plurality of different levels of access privileges (e.g., read access, write access, and/or admin access). Embodiments of the present invention recognize that granting access to a document, file, folder, and/or album may be required while simultaneously attending meeting, conversation, collaborative activities, and/or any other activities known and/or understood in the art.

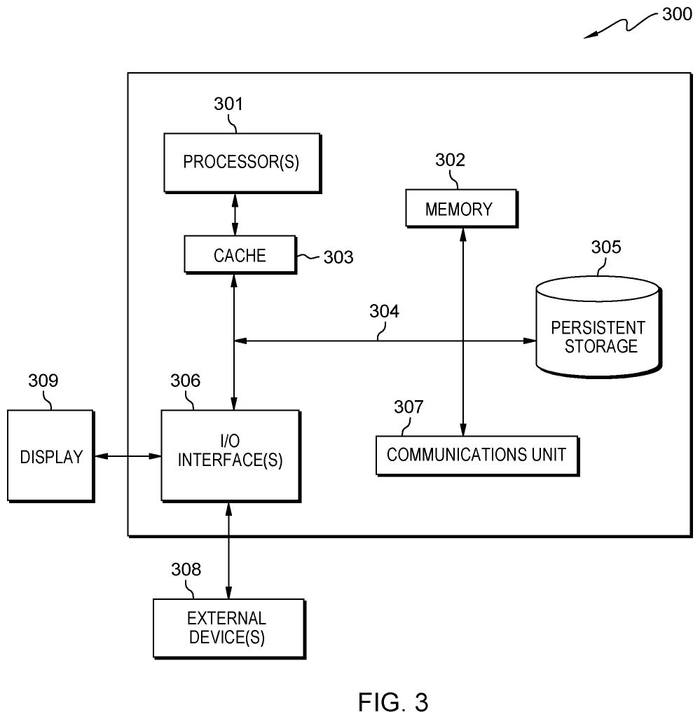

Embodiments of the present invention recognize that in different scenarios, if a primary user (i.e., administrator) grants access to multiple users for different folders, files content, and/or any other data that requires permission access, then the activity can become mechanical, tedious and boring. Asset or data access management may be executed by a primary user, wherein the primary user may perform general role-based data asset access, where one such role could be executed by an administrator, a supervisor, a steward, a super user, an asset owner, a general user, and/or any other user that can perform data asset access known and understood in the art. Further, embodiments of the present invention recognize that while having a virtual reality interaction (e.g., virtual meeting), if a first user is instructed to grant a second user access to a file or folder, then the first user grants access to the file or folder while leveraging VR interaction. Additionally, embodiments recognize that gamification is needed for granting access to one or more users in any document repository. The gamification would be based on the VR experience created by the system as demonstrated in FIG. 3. For instance, to gain access to an asset (e.g., data), a user would need to virtually request access from the owner in order to walk through the “gate” guarding the files located within a library on a bookshelf behind the gate. In this instance, the gamified element(s) would be around requesting access, time to grant access, how long the gate would be held open, how long the user is granted access, and/or any other data access management elements known and understood in the art. Similarly, the owner of the asset would be able to place avatars, via the virtual reality environment, next to assets to “indicate” access has been granted, further the primary user (e.g., owner) would also be able to track access for the duration, by virtually tracking the activity of the people who were granted the access.

Embodiments of the present invention improve the art and solve the issues stated above by utilizing a virtual reality interface for controlling access to documents. Additionally, embodiments of the present invention improve the art and solve the issues stated above by (i) providing a virtual reality interface depicting visual representations mapping to corresponding entities that enable a first user to control access of a second user to documents contained in a repository, wherein the virtual reality interface provides a representation of the first user mapping to the second user, a representation of the documents mapping to the documents, and a representation of access controls mapping to access controls, and wherein the virtual reality interface supports gestures targeted to the representations for granting access, revoking access, adding documents, and removing documents; and (ii) updating the visual representation and the corresponding mapped entities based on received user gestures against the visual representation. Additionally, embodiments of the present invention improve the art and solve the issues stated above by utilizing compartments in the bookshelf to represent structures (e.g., folders) for holding documents, and providing a representation of roles corresponding to authorization privileges. In various embodiments, the visual representation is a virtual visual representation displayed in/or virtual reality and/or augmented reality devices. In various embodiments, the documents may represent books on a bookshelf, avatars representing users, and gates represent access controls. The virtual reality interface supported gestures may be, for example, a user using a hand to request access at the gate (like typing in request code at the gate), the asset owner using hands to assign avatars to assets, moving assets within a virtualized library from one shelf to another in order to indicate change in access entitlements (e.g., a public or protected asset becoming private).

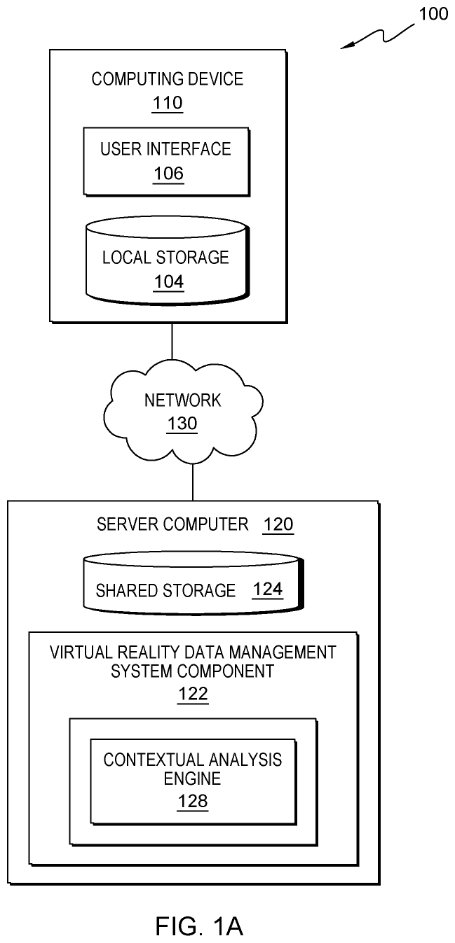

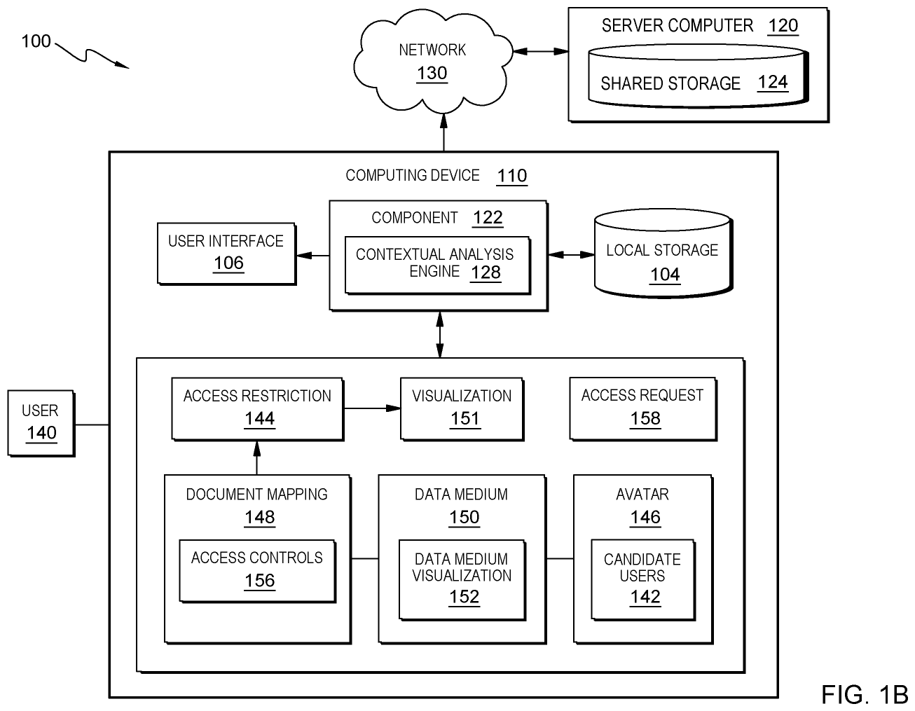

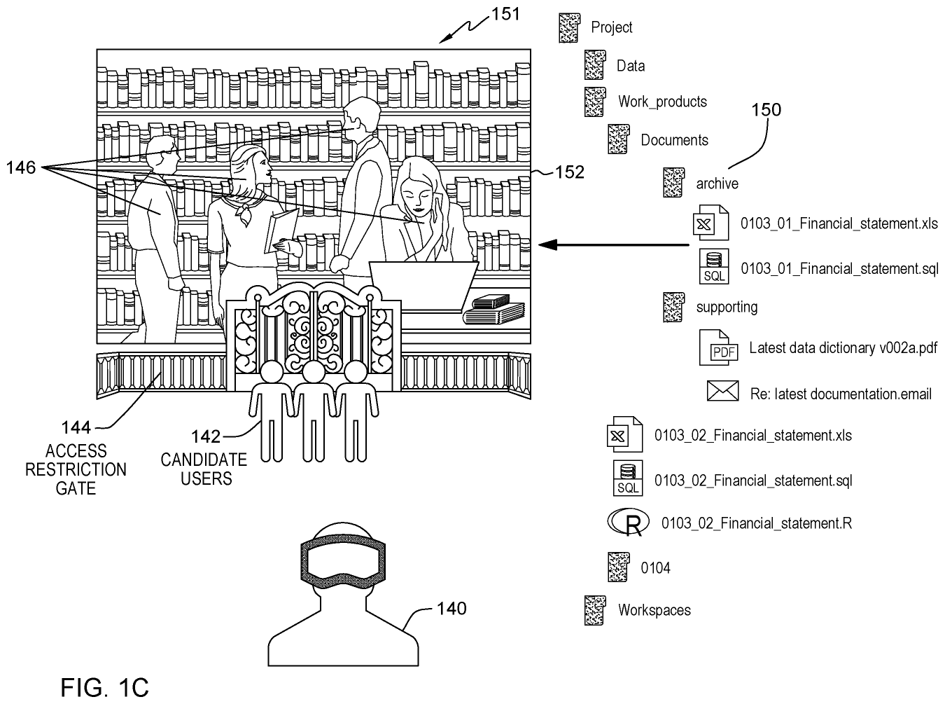

Implementation of embodiments of the invention may take a variety of forms, and exemplary implementation details are discussed subsequently with reference to the Figures (i.e., FIG. 1A-FIG. 3).

FIG. 1A is a functional block diagram illustrating a distributed data processing environment, generally designated 100, in accordance with one embodiment of the present invention. The term “distributed” as used in this specification describes a computer system that includes multiple, physically distinct devices that operate together as a single computer system. FIG. 1A provides only an illustration of one implementation and does not imply any limitations with regard to the environments in which different embodiments may be implemented. Many modifications to the depicted environment may be made by those skilled in the art without departing from the scope of the invention as recited by the claims. Distributed data processing environment 100 includes computing device 110 and server computer 120 interconnected over network 130.

Network 130 may be, for example, a storage area network (SAN), a telecommunications network, a local area network (LAN), a wide area network (WAN), such as the Internet, a wireless technology for exchanging data over short distances (using short-wavelength ultra-high frequency (UHF) radio waves in the industrial, scientific and medical (ISM) band from 2.4 to 2.485 GHz from fixed and mobile devices, and building personal area networks (PANs) or a combination of the three), and may include wired, wireless, or fiber optic connections. Network 130 may include one or more wired and/or wireless networks that may receive and transmit data, voice, and/or video signals, including multimedia signals that include voice, data, text and/or video data. In general, network 130 may be any combination of connections and protocols that will support communications between computing device 110 and server computer 120, and any other computing devices and/or storage devices (not shown in FIG. 1A) within distributed data processing environment 100.

In some embodiments of the present invention, computing device 110 may be, but is not limited to, a standalone device, a client, a server, a laptop computer, a tablet computer, a netbook computer, a personal computer (PC), a smart phone, a desktop computer, a smart television, a smart watch, a radio, a stereo system, a cloud based service (e.g., a cognitive cloud based service), AR glasses, a virtual reality headset, any HUD known in the art, and/or any programmable electronic computing device capable of communicating with various components and devices within distributed data processing environment 100, via network 130 or any combination therein. In general, computing device 110 may be representative of any programmable computing device or a combination of programmable computing devices capable of executing machine-readable program instructions and communicating with users of other computing devices via network 130 and/or capable of executing machine-readable program instructions and communicating with server computer 120. In some embodiments computing device 110 may represent a plurality of computing devices.

In some embodiments of the present invention, computing device 110 may represent any programmable electronic computing device or combination of programmable electronic computing devices capable of executing machine readable program instructions, manipulating executable machine-readable instructions, and communicating with server computer 120 and other computing devices (not shown) within distributed data processing environment 100 via a network, such as network 130. Computing device 110 may include an instance of user interface (interface) 106, and local storage 104. In various embodiments, not depicted in FIG. 1A, computing device 110 may have a plurality of interfaces 106. In other embodiments, not depicted in FIG. 1A, distributed data processing environment 100 may comprise a plurality of computing devices, plurality of server computers, and/or one a plurality of networks. Computing device 110 may include internal and external hardware components, as depicted, and described in further detail with respect to FIG. 3.

User interface (interface) 106 provides an interface to virtual reality integration (component) 122. Computing device 110, via user interface 106, may enable a user and/or a client to interact with component 122 and/or server computer 120 in various ways, such as sending program instructions, receiving program instructions, sending and/or receiving messages, updating data, sending data, inputting data, editing data, collecting data, and/or receiving data. In one embodiment, interface 106 may be a graphical user interface (GUI) or a web user interface (WUI) and may display at least text, documents, web browser windows, user options, application interfaces, and instructions for operation. interface 106 may include data (such as graphic, text, and sound) presented to a user and control sequences the user employs to control operations. In another embodiment, interface 106 may be a mobile application software providing an interface between a user of computing device 110 and server computer 120. Mobile application software, or an “app,” may be designed to run on smart phones, tablet computers and other computing devices. In an embodiment, interface 106 may enable the user of computing device 110 to at least send data, input data, edit data (annotations), collect data and/or receive data.

Server computer 120 may be a standalone computing device, a management server, a web server, a mobile computing device, one or more client servers, or any other electronic device or computing system capable of receiving, sending, and processing data. In other embodiments, server computer 120 may represent a server computing system utilizing multiple computers such as, but not limited to, a server system, such as in a cloud computing environment. In another embodiment, server computer 120 may represent a computing system utilizing clustered computers and components (e.g., database server computers, application server computers, etc.) that act as a single pool of seamless resources when accessed within distributed data processing environment 100. Server computer 120 may include internal and external hardware components, as depicted, and described in further detail with respect to FIG. 3. In some embodiments server computer 120 may represent a plurality of server computers.

Each of shared storage 124 and local storage 104 may be a data/knowledge repository and/or a database that may be written and/or read by one or a combination of component 122, server computer 120 and computing device 110. In some embodiments, each of shared storage 124 and local storage 104 may be a data/knowledge repository, a knowledge base, a knowledge center, a knowledge corpus, and/or a database that may be written and/or read by one or a combination of component 122, server computer 120 and computing device 110. In the depicted embodiment, shared storage 124 resides on server computer 120 and local storage 104 resides on computing device 110. In another embodiment, shared storage 124 and/or local storage 104 may reside elsewhere within distributed data processing environment 100, provided that each may access and is accessible by computing device 110 and server computer 120. Shared storage 124 and/or local storage 104 may each be implemented with any type of storage device capable of storing data and configuration files that may be accessed and utilized by server computer 120, such as, but not limited to, a database server, a hard disk drive, or a flash memory. In various embodiments, not depicted in FIG. 1A, in addition to shared storage 124, server computer comprises a primary and a secondary database, described below in FIG. 3. The primary database, also referred to as primary storage device, may be one or more of any type of disk storage known in the art. The secondary database, also referred to as secondary storage device, may be one or more any type of tape storage known in the art.

In the depicted embodiment, component 122 is executed on server computer 120. In other embodiments, component 122 may be executed on computing device 110. In various embodiments of the present invention, not depicted in FIG. 1A, component 122 may execute on a plurality of server computers 120 and/or on a plurality of computing devices 110. In some embodiments, component 122 may be located and/or executed anywhere within distributed data processing environment 100 as long as component 122 is connected to and/or communicates with, computing device 110, and/or server computer 120, via network 130. In the depicted embodiment, component 122 comprises contextual analysis engine 128.

In various embodiments of the present invention, not depicted in FIG. 1A, knowledge corpus may each execute on a plurality of server computers 120 and/or on a plurality of computing devices 110. In some embodiments, knowledge corpus may be located and/or executed anywhere within distributed data processing environment 100 if the knowledge corpus is connected to and/or communicates with, computing device 110, component 122, and/or server computer 120, via network 130. In various embodiments, component 122, via contextual analysis engine 128, creates one or more virtual reality visualizations (i.e., visualization/ virtual visualization) of the one or more captured images. In various embodiments of the present invention, contextual analysis engine 128 may each execute on a plurality of server computers 120 and/or on a plurality of computing devices 110. In some embodiments, contextual analysis engine 128 may be located and/or executed anywhere within distributed data processing environment 100 as long as contextual analysis engine 128 are connected to and/or communicates with, computing device 110, component 122, and/or server computer 120, via network 130.

In various embodiments, while performing an activity in the physical world, a user can wear a VR device to visualize a virtual representation of a real-world location, event, experience, and/or scenario. Component 122 may create, through a virtual reality gamification system, virtual reality surroundings that enable access to an avatar of a candidate user. In various embodiments, while granting access to one or more files or folders for a specific user (i.e., a second user) or a group of users, component 122, via a virtual reality system on a virtual reality device (e.g., computing device 110), creates a virtual realty user interface which generates and displays similar environment and/or virtual layouts of the one or more files and the one or more folders structure along with an access granting mechanism that will be provided to the admin with VR user interface. In various embodiments, component 122, via computing device 110, creates a virtual reality avatar of the candidate users who are requesting access to the data (e.g., files, folders, and/or any other forms of data known in the art with a user interface and administrative (admin) action in the virtual reality environment, wherein the admin can grant access to the avatar of the candidate users. Component 122 may create a virtual reality user interface of the data (e.g., files and folder structure), wherein component 122 may classify the documents or folders, and accordingly, component 122 creates a virtual reality visualization for the file and folders, and enable a primary user to grant access to the candidate users (i.e., secondary users).

In various embodiments, component 122 enables an admin to selectively revoke access to one or more users from accessing one or more files and folders, wherein component 122, via computing device 110 (e.g., a VR system) creates and displays a user interface comprising administrator actions, and wherein the data access (i.e., access to the one or more files and/or folders) can be revoked. Component 122 may classify the virtual reality avatars of the users based on roles and responsibilities of the candidate users (i.e., secondary users), and accordingly output and display, via interface 106, a visualization of the secondary users who are currently granted access to the files and folders. In various embodiments, responsive to receiving instructions from a user (e.g., administrator), component 122 selectively adds or removes one or more files and/or folders and accordingly, grant or revoke access to the files or folders in a selective manner. Based on interactions with a user (e.g., administrator) in the VR environment, component 122 may dynamically allocate and grant security access to a plurality of candidate users. In various embodiments, component 122 enables a user (e.g., an administrator) to assign security roles to secondary users based on interface 106 (e.g., virtual reality user interface), wherein the assigned security roles are visualized in the VR environment displayed, via computing device 110, and wherein the user may grant or revoke secondary user access to one or more data mediums.

In various embodiments, component 122 creates an immersive user experience, in a virtual reality environment, for access management. Component 122 may identify files, folders, and/or user groups to which the access is to be provided and/or requested. In various embodiments, component 122 comprises contextual analysis engine 128, wherein contextual analysis engine 128 analyzes where access (e.g., user access/permission) is provided. In various embodiments, if access is provided to a data medium (e.g., a file or folder), then contextual analysis engine 128 performs a contextual analysis of the content within the file/folder. Based on the contextual analysis, component 122 may identify one or more files and/or folders individually and classify the identified one or more files and/or folders.

In various embodiments, component 122 analyzes one or more data medium structures (e.g., file and folder structure) located on server computer 120 (e.g., cloud hosted server) and/or local storage 104. Component 122 may create and display a visualization based on the analyzed one or more data medium structures (e.g., file and folder structure) and context of the data medium (e.g., documents or folder metadata within the file and folder structure). For example, a file and folder structure is depicted (i.e., visualized) as bookshelf in a Library, wherein each book is mapped to a file. In similar examples, in addition to managing access to files, component 122 considers content (e.g., code within a code repository on local storage 104 and/or shared storage 124), wherein the considered content is represented as a visualization in the virtual reality environment (e.g., represented as books with a library). Based on the contextual analysis of the content and data medium, component 122 may generate labels (e.g., names) and dynamically label each book virtually displayed on the visualized bookshelf, wherein each book corresponds to identified data medium (e.g., files and/or folders). In some embodiments, a folder structure may be organized as a room, or a shelf, wherein the virtual reality visualization creates individual rooms or passages with gates acting as access restriction points.

In some embodiments, files requiring administrator access may be virtually rendered with lock and/or chain, or comprising an interface to enable a user, via interface 106 and the user's avatar to enter an access code, wherein the user receives the access code from the admin upon receiving permission to access the restricted data medium (e.g., file and/or folder) from the administrator. In various embodiments, component 122 identifies and categorizes secondary users into two groups, wherein the first group comprises users who lack administrative access and/or are requesting administrative access to one or more data medium and the second group comprises users who have and/or have been granted administrative access, and wherein component 122 creates a virtual avatar of users in the second group. In some embodiments, the generated user avatars are predetermined, based on a preloaded user profile image, and/or are customizable by the user.

In various embodiments, component 233 may analyze the roles of a plurality of users and group the plurality of users based on the analysis. In some embodiments, if a user group does not exist for an identified role, then component 122 will create a new user group for the identified role. In various embodiment, component 122 creates a virtual reality interface for one or more user groups, wherein the one or more user groups can comprise multiple files and/or folder access. In some embodiments, component 122, via computing device 110 (e.g., virtual reality system), creates and displays a user interface to virtually display the user group. In various embodiments, component 122 generates bookshelf visualization for file and folder structure or any other equivalent visualization. In some embodiments, if a secondary user or group of secondary users are identified for new access, then component 122 creates a visualization of the candidate users. In various embodiments, responsive to a primary user selectively identifying, engaging and/or granting access to one or more avatars of one or more secondary users, component 122 enables the selected secondary user to access a requested or predetermined data medium (i.e., grants access to one or more data medium visualizations (e.g., granting user access to one or more books, a group of books, one or more rooms, and/or any other generated visualizations)). In various embodiments, responsive to a user removing a corresponding avatar from the surrounding visualization, component 122 removes the granted permission from the user of the corresponding avatar. In some embodiments, component 122 generates and outputs a user interface corresponding to a particular situation. For example, if component 122 is interacting with a group of users, then component 122 will generate and virtually display a conference room comprising the users as the user interface, wherein the users are arranged in circle around the room or table and the conference room is named after the group of users or a predetermined name.

Component 122 may provide a virtual reality interface depicting visual representations mapping to corresponding entities that enable a first user to control access of a second user to documents contained in a repository, wherein the virtual reality interface provides a representation of the first user mapping to the second user, a representation of the documents mapping to the documents, and a representation of access controls mapping to access controls, and wherein the virtual reality interface supports gestures targeted to the representations for granting access, revoking access, adding documents, and removing documents. Further, component 122 may update the visual representation and the corresponding mapped entities based on received user gestures against the visual representation. Additionally, component 122 may improve the art and solve the issues stated above by utilizing compartments in the bookshelf to represent structures [e.g., folders] for holding documents, and providing a representation of roles corresponding to authorization privileges. In various embodiments, the documents may represent books on a bookshelf, avatars representing users, and gates represent access controls.

FIG. 1B is a functional block diagram illustrating a distributed data processing environment, generally designated 100, in accordance with one embodiment of the present invention. The term “distributed” as used in this specification describes a computer system that includes multiple, physically distinct devices that operate together as a single computer system. FIG. 1B provides only an illustration of one implementation and does not imply any limitations with regard to the environments in which different embodiments may be implemented. Many modifications to the depicted environment may be made by those skilled in the art without departing from the scope of the invention as recited by the claims. Distributed data processing environment 100 includes computing device 110, user 140, and server computer 120 interconnected over network 130.

In the depicted embodiment, user 140 is wearing a virtual reality headset represented by computing device 110. In other embodiments, computing device 110 may represent an augmented reality device and/or any other type or virtual reality device known and understood in the art. In the depicted embodiment, candidate users 142 (i.e., secondary users) submit access request 158 to access data medium 150 to user 140. Component 122, via contextual analysis engine 128, analyzes data medium 150 and generates data medium visualization 152 based on the analyzed data medium 150, wherein data medium visualization 152 is displayed with visualization 151 in user interface 106. The displayed data medium visualization 152 and visualization 151 may map to corresponding entities that enable user 140 to control access of candidate users 142 to data contained in a repository (e.g., data medium 150), wherein the virtual reality interface (i.e., interface 106) provides a representation of user 140 mapping to candidate users 142, a representation of the data mapping 148 to data medium 150, and a representation of access controls 156 mapping to access controls 156, and wherein the virtual reality interface (i.e., interface 106) supports gestures targeted to the representations for granting access, revoking access, adding documents, and removing documents.

User 140 may user interface 106 to interact with visualization 151 and respond to candidate users 142 access request 158. Responsive to receiving instructions from user 140 to grant access to candidate users 142 to access data medium 150, component 122 generates avatar 146 for each candidate users 142 who was granted access to data medium 150. Component 122 may depict candidate users 142 in visualization 151 outside/in front of access restriction gate 144, wherein candidate users 142 are users who lack access and/or are requesting access to data medium 150. In the depicted embodiment, avatars 146 represent the avatars of users who have been granted access to data medium 150, thus avatars 146 are depicted inside/behind access restriction gate 144 near/around data medium visualizations 152 (e.g., books and shelves).

FIG. 1C is a functional block diagram illustrating a distributed data processing environment, generally designated 100, in accordance with one embodiment of the present invention. The term “distributed” as used in this specification describes a computer system that includes multiple, physically distinct devices that operate together as a single computer system. FIG. 1C provides only an illustration of one implementation and does not imply any limitations with regard to the environments in which different embodiments may be implemented. Many modifications to the depicted environment may be made by those skilled in the art without departing from the scope of the invention as recited by the claims. Distributed data processing environment 100 includes computing device 110, user 140, and server computer 120 interconnected over network 130.

More specifically, FIG. 1C, depicts an example of a virtual reality environment and user interface being displayed to a user (e.g., user 140), via computing device 110, for managing user data access, in accordance with one embodiment of the invention. In the depicted embodiment, user 140 represents an administrator wearing computing device 110 (e.g., a virtual reality headset) and viewing a generated user interface (i.e., interface 106) through computing device 110. Data medium 150 represent a files and folders structure that requires access to be granted by user 140. Further, in the depicted embodiment, data medium 150 are virtually depicted as books and shelves in data medium visualizations 152 in a library within visualization 151, wherein visualization 151 is displayed on interface 106 on computing device 110 to user 140. Additionally, in the depicted embodiment, candidate users 142 are depicted/represented in visualization 151 outside/in front of access restriction gate 144, wherein candidate users 142 are users who lack access and/or are requesting access to data medium 150. In the depicted embodiment, avatars 146 represent the avatars of users who have been granted access to data medium 150, thus avatars 146 are depicted inside/behind access restriction gate 144 near/around the books and shelves in data medium visualizations 152. In various embodiments, if user 140 selects a user from candidate users 142 then component 122 generates an avatar for the selected user and the selected user is removed from candidate user 142 and the selected user avatar is displayed inside access restriction gate 144 near/around the books and shelves in data medium visualizations 152.

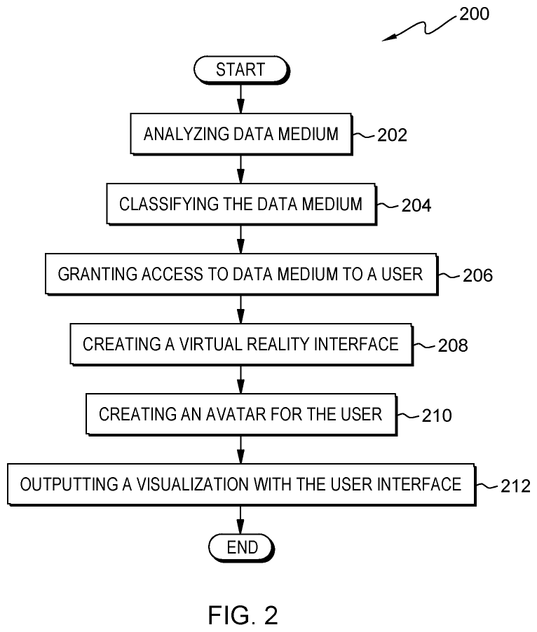

FIG. 2 illustrates operational steps of component 122, generally designated 200, in communication with server computer 120, within distributed data processing environment 100 of FIG. 1A and/or FIG. 1B, for rendering objects in a peripheral viewing area as static, in accordance with an embodiment of the present invention. FIG. 2 provides an illustration of one implementation and does not imply any limitations with regard to the environments in which different embodiments may be implemented. Many modifications to the depicted environment may be made by those skilled in the art without departing from the scope of the invention as recited by the claims.

In step 202, component 122 analyzes one or more data medium. In various embodiments, component 122 analyzes one or more data medium on local storage 104 and/or shared storage 124. In various embodiments, component 122 analyzes one or more data medium structures (e.g., file and folder structure) located on server computer 120 (e.g., cloud hosted server) and/or local storage 104.

In step 204, classifies the data medium. In various embodiments, component 122 may classify the data medium (e.g., documents or folders) and generate a virtual reality visualization of the classified data medium, wherein the generated virtual reality visualization enables a primary user (e.g., administrator) to grant access to the candidate users.

In step 206, component 122 grants access to the data medium to a user. In various embodiments, responsive to receiving instructions from a primary user, component 122 grants access to one or more data medium to one or more users.

In step 208, component 122 creates a virtual reality interface. In various embodiments, component 122 creates and displays a visualization based on the analyzed one or more data medium structures (e.g., file and folder structure) and context of the data medium (e.g., documents or folder metadata). For example, a file and folder structure is depicted (i.e., visualized) as bookshelf in a Library, wherein each book is mapped to a file. In similar examples, in addition to managing access to files, component 122 considers content (e.g., code within a code repository on local storage 104 and/or shared storage 124), wherein the considered content is represented as a visualization in the virtual reality environment (e.g., represented as books with a library). Based on the contextual analysis of the content and data medium, component 122 may generate labels (e.g., names) and dynamically label each book virtually displayed on the visualized bookshelf, wherein each book corresponds to identified data medium (e.g., files and/or folders).

In step 210, creates an avatar of the user who was granted access to the data medium. In various embodiments, component 122 identifies and categorizes secondary users into two groups, wherein the first group comprises users who lack administrative access and/or are requesting administrative access to one or more data medium and the second group comprises users who have and/or have been granted administrative access, and wherein component 122 creates a virtual avatar of users in the second group. In some embodiments, the generated user avatars are a predetermined character, based on a preloaded user profile image, and/or are customizable by the user. In various embodiments, responsive to a primary user selectively identifying, engaging and/or granting access to one or more avatars of one or more secondary users, component 122 enables the selected secondary user to access a requested or predetermined data medium (i.e., grants access to one or more data medium visualizations (e.g., granting user access to one or more books, a group of books, one or more rooms, and/or any other generated visualizations)).

In step 212, component 122 outputs a visualization of the generated virtual environment, user interface, and secondary user avatars. In various embodiments, component 122 displays similar environment and/or virtual layouts of the one or more files and the one or more folder's structure along with an access granting mechanism that will be provided to the admin with VR user interface. In various embodiments, component 122 displays responsive prompts to the user, via computing device 110, that enable a user to confirm commands, execute commands, and/or input feedback. In various embodiments, component 122 generates and outputs, via interface 106, responsive prompts that query the user to accept and/or rate the generated/output visualization, wherein responsive to receiving feedback from a user component 122 updates the output visualization based on the received user feedback and/or stores the user feedback and visualizations for future use to a knowledge corpus, shared storage 124, and local storage 104.

FIG. 3 depicts a block diagram of components of server computer 120 within distributed data processing environment 100 of FIG. 1A and/or FIG. 1B, in accordance with an embodiment of the present invention. It should be appreciated that FIG. 3 provides only an illustration of one implementation and does not imply any limitations with regard to the environments in which different embodiments may be implemented. Many modifications to the depicted environment may be made.

FIG. 3 depicts computer system 300, where server computing 120 represents an example of computer system 300 that includes component 122. The computer system includes processors 301, cache 303, memory 302, persistent storage 305, communications unit 307, input/output (I/O) interface(s) 306, display 309, external device(s) 308 and communications fabric 304. Communications fabric 304 provides communications between cache 303, memory 302, persistent storage 305, communications unit 307, and input/output (I/O) interface(s) 306. Communications fabric 304 may be implemented with any architecture designed for passing data and/or control information between processors (such as microprocessors, communications, and network processors, etc.), system memory, peripheral devices, and any other hardware components within a system. For example, communications fabric 304 may be implemented with one or more buses or a crossbar switch.

Memory 302 and persistent storage 305 are computer readable storage media. In this embodiment, memory 302 includes random access memory (RAM). In general, memory 302 may include any suitable volatile or non-volatile computer readable storage media. Cache 303 is a fast memory that enhances the performance of processors 301 by holding recently accessed data, and data near recently accessed data, from memory 302.

Program instructions and data used to practice embodiments of the present invention may be stored in persistent storage 305 and in memory 302 for execution by one or more of the respective processors 301 via cache 303. In an embodiment, persistent storage 305 includes a magnetic hard disk drive. Alternatively, or in addition to a magnetic hard disk drive, persistent storage 305 may include a solid-state hard drive, a semiconductor storage device, read-only memory (ROM), erasable programmable read-only memory (EPROM), flash memory, or any other computer readable storage media that is capable of storing program instructions or digital information.

The media used by persistent storage 305 may also be removable. For example, a removable hard drive may be used for persistent storage 305. Other examples include optical and magnetic disks, thumb drives, and smart cards that are inserted into a drive for transfer onto another computer readable storage medium that is also part of persistent storage 305.

Communications unit 307, in these examples, provides for communications with other data processing systems or devices. In these examples, communications unit 307 includes one or more network interface cards. Communications unit 307 may provide communications through the use of either or both physical and wireless communications links. Program instructions and data used to practice embodiments of the present invention may be downloaded to persistent storage 305 through communications unit 307.

I/O interface(s) 306 enables for input and output of data with other devices that may be connected to each computer system. For example, I/O interface 306 may provide a connection to external devices 308 such as a keyboard, keypad, a touch screen, and/or some other suitable input device. External devices 308 may also include portable computer readable storage media such as, for example, thumb drives, portable optical or magnetic disks, and memory cards. Software and data used to practice embodiments of the present invention may be stored on such portable computer readable storage media and may be loaded onto persistent storage 305 via I/O interface(s) 306. I/O interface(s) 306 also connect to display 309.

Display 309 provides a mechanism to display data to a user and may be, for example, a computer monitor.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The present invention may be a system, a method, and/or a computer program product. The computer program product may include a computer readable storage medium (or media) having computer readable program instructions thereon for causing a processor to carry out aspects of the present invention.

The computer readable storage medium may be any tangible device that may retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein may be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, may be implemented by computer readable program instructions.

These computer readable program instructions may be provided to a processor of a general-purpose computer, a special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that may direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus, or other device to produce a computer implemented process, such that the instructions which execute on the computer, other programmable apparatus, or other device implement the functions/acts specified in the flowchart and/or block diagram block or blocks.

The flowchart and block diagrams in the Figures (i.e., FIG.) illustrate the architecture, functionality, and operation of possible implementations of systems, methods, and computer program products according to various embodiments of the present invention. In this regard, each block in the flowchart or block diagrams may represent a module, a segment, or a portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, may be implemented by special purpose hardware-based systems that perform the specified functions or acts or carry out combinations of special purpose hardware and computer instructions.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the invention. The terminology used herein was chosen to best explain the principles of the embodiment, the practical application or technical improvement over technologies found in the marketplace, or to enable others of ordinary skill in the art to understand the embodiments disclosed herein.

What is claimed is:

1. A computer-implemented method for managing user access to data using a virtual reality environment, the computer-implemented method comprising:
generating a virtual reality interface depicting visual representations mapped to corresponding documents, wherein the virtual reality interface provides a visual representation of mapped secondary users, and of mapped access controls;
enabling a primary user to control secondary user access to documents contained in a repository; and
responsive to receiving user gestures corresponding to the visual representations, updating the visual representation and the corresponding mapped documents.

2. The computer-implemented method of claim 1, wherein the virtual reality interface supports gestures targeted to a representation for granting access to the secondary user, revoking the granted access, adding new documents, and removing the corresponding documents or the new documents.

3. The computer-implemented method of claim 1, further comprising:
displaying responsive prompts to the primary user, through a computing device, that enable primary user to confirm a command, execute the command, and input feedback.

4. The computer-implemented method of claim 1, further comprising:
analyzing, by a contextual analysis engine, the corresponding documents; and
classifying, by the contextual analysis engine, the documents.

5. The computer-implemented method of claim 1, further comprising:
responsive to receiving instruction from the primary user, granting access to the documents to the secondary user.

6. The computer-implemented method of claim 5, further comprising:
creating a virtual reality avatar of the secondary user, wherein the created virtual reality avatar is a predetermined character.

7. The computer-implemented method of claim 1, further comprising:
displaying, by a virtual reality device, a visualization based on an analyzed data medium structure and context of data medium within the data medium structure, wherein each element in the visualization is mapped to a file or folder.

8. A computer system for managing user access to data using a virtual reality environment, the computer system comprising:
one or more computer processors;
one or more computer readable storage devices;
program instructions stored on the one or more computer readable storage devices for execution by at least one of the one or more computer processors, the stored program instructions comprising:
program instructions to generate a virtual reality interface depicting visual representations mapped to corresponding documents, wherein the virtual reality interface provides a visual representation of mapped secondary users, and of mapped access controls;
program instructions to enable a primary user to control secondary user access to documents contained in a repository; and
responsive to receiving user gestures corresponding to the visual representations, program instructions to update the visual representation and the corresponding mapped documents.

9. The computer system of claim 8, wherein the virtual reality interface supports gestures targeted to a representation for granting access to the secondary user, revoking the granted access, adding new documents, and removing the corresponding documents or the new documents.

10. The computer system of claim 8, further comprising:
program instructions to display responsive prompts to the primary user, through a computing device, that enable primary user to confirm a command, execute the command, and input feedback.

11. The computer system of claim 8, further comprising:
program instructions to analyze, by a contextual analysis engine, the corresponding documents; and
program instructions to classify, by the contextual analysis engine, the documents.

12. The computer system of claim 8, further comprising:
responsive to receiving instruction from the primary user, program instructions to grant access to the documents to the secondary user.

13. The computer system of claim 12, further comprising:
program instructions to create a virtual reality avatar of the secondary user, wherein the created virtual reality avatar is a predetermined character.

14. The computer system of claim 8, further comprising:
program instructions to display, by a virtual reality device, a visualization based on an analyzed data medium structure and context of data medium within the data medium structure, wherein each element in the visualization is mapped to a file or folder.

15. A computer program product for managing user access to data using a virtual reality environment, the computer program product comprising:
one or more computer readable storage devices and program instructions stored on the one or more computer readable storage devices, the stored program instructions comprising:
program instructions to;
program instructions to generate a virtual reality interface depicting visual representations mapped to corresponding documents, wherein the virtual reality interface provides a visual representation of mapped secondary users, and of mapped access controls;
program instructions to enable a primary user to control secondary user access to documents contained in a repository; and
responsive to receiving user gestures corresponding to the visual representations, program instructions to update the visual representation and the corresponding mapped documents.

16. The computer program product of claim 15, wherein the virtual reality interface supports gestures targeted to a representation for granting access to the secondary user, revoking the granted access, adding new documents, and removing the corresponding documents or the new documents.

17. The computer program product of claim 15, further comprising:
program instructions to display responsive prompts to the primary user, through a computing device, that enable primary user to confirm a command, execute the command, and input feedback.

18. The computer program product of claim 15, further comprising:
program instructions to analyze, by a contextual analysis engine, the corresponding documents; and
program instructions to classify, by the contextual analysis engine, the documents.

19. The computer program product of claim 15, further comprising:
responsive to receiving instruction from the primary user, program instructions to grant access to the documents to the secondary user; and
program instructions to create a virtual reality avatar of the secondary user, wherein the created virtual reality avatar is a predetermined character.

20. The computer program product of claim 15, further comprising:
program instructions to display, by a virtual reality device, a visualization based on an analyzed data medium structure and context of data medium within the data medium structure, wherein each element in the visualization is mapped to a file or folder.
